(19) United States
(12) Patent Application Publication
(10) Pub. No.: US 2020/0268488 A1
(43) Pub. Date: Aug. 27, 2020

(54) DENTAL PROSTHESIS

(71) Applicant: Jeounghun Kim, Coquitlam (CA)

(72) Inventor: Jeounghun Kim, Coquitlam (CA)

(21) Appl. No.: 16/282,685

(22) Filed: Feb. 22, 2019

(51) Int. Cl. A61C 13/271; A61C 13/275; A61C 5/70

(52) U.S. Cl. CPC A61C 13/26; A61C 5/70; A61C 13/275

(57) ABSTRACT

A dental prothesis configured to be placed in a gap between a first adjoining tooth and a second adjoining tooth so as to replace a missing tooth. The prothesis includes two partial abutments configured to sit within the gap between the two adjoining teeth. Secured to each partial abutment is a connector which is also secured to one of the adjoining teeth. Each connector is in a substantially C-shape configuration and adapted to fit along the surface of the associated adjoining tooth. The connectors have a plurality of connecting points that are adapted to fit within one of a plurality of retention grooves ground in the adjoining teeth to affix the connectors to the adjacent teeth with little grinding of the adjacent teeth. A crown is adapted to fit over and about the two partial abutments.

### REFERENCE TO PENDING APPLICATIONS

This application does not claim the benefit of any issued U.S. patent or pending application.

### TECHNICAL FIELD

The present invention is generally directed toward a dental prosthesis, and specifically toward a dental bridge prothesis.

### BACKGROUND

One or more teeth can be decayed due to a diversity of dental diseases, or can otherwise be lost. In an attempt to replace a lost tooth, a dental prosthesis is employed, so that a masticating function, an aesthetic appearance and a normal pronunciation are recovered.

A general dental prosthesis which functions to replace a decayed tooth with an artificial tooth, is used, as can be readily seen from FIG. 1, in a manner such that a pair of cap segments 11 which respectively define inner spaces corresponding to contours of two adjoining teeth 14, are integrally connected to an artificial tooth 12 so as to fixedly maintain the artificial tooth 12 and the entire dental prosthesis is fitted on the two adjoining teeth 14.

Since the dental prosthesis which is fitted on the two adjoining teeth 12, has a shape which is similar to that of a crown, the general dental prosthesis is called a crown bridge 10.

While the crown bridge 10 provides advantages in that the prosthetic dentistry is simplified and the cost is reduced, due to the fact that the two adjoining teeth 14 which are respectively located at both sides of the artificial tooth 12, must be ground down by a thickness corresponding to the pair of cap segments 11 used for fixedly maintaining the artificial tooth 12, the two adjoining teeth 14 which are normally healthy, can be damaged. Also, if air, foreign substances and so forth flow into gaps which are defined between the two adjoining teeth 14 and the pair of cap segments 11, a serious problem can be induced in that the healthy teeth can begin to decay.

Accordingly, there is a need to satisfy the challenges set out above.

### SUMMARY

The present invention is generally directed toward a dental prothesis, and specifically toward a dental bridge prothesis.

In one aspect, a dental prothesis is configured to be placed in a gap between a first adjoining tooth and a second adjoining tooth so as to replace a missing tooth. The prothesis includes a first partial abutment configured to sit within the gap. A first connector is secured to the first partial abutment and to the first adjoining tooth. The first connector has a substantially C-shape configuration and is adapted to fit along the surface of the first adjoining tooth. The first connector also has a plurality of first connector “connecting points”, where each first connector “connecting point” is adapted to fit within one of a plurality of first retention grooves ground in the first adjoining tooth to fix the first connector to the first adjacent tooth with little grinding of the first adjacent tooth.

The prothesis also includes a second partial abutment configured to sit within the gap. A second connector is secured to the second partial abutment and to the second adjoining tooth. The second connector has a substantially C-shape configuration and is adapted to fit along the surface of the second adjoining tooth. The second connector also has a plurality of second connector “connecting points”, where each second connector “connecting point” is adapted to fit within one of a plurality of second retention grooves ground in the second adjoining tooth to fix the second connector to the second adjacent tooth with little grinding of the second adjacent tooth. A crown is adapted to fit over and about the first and second partial abutments.

In some aspects, the first and second connector may be made from metal material or zirconia material.

In some aspects, the number of the plurality of connecting points for both the first and second connectors is four. The four connecting points may be defined as a mesial occlusion connection point which is adapted to fit within a mesial occlusion groove located on the associated first or second adjoining tooth, a distal occlusion connection point which is adapted to fit within a distal occlusion groove located on the associated first or second adjoining tooth, a mesiobuccal connection point which is adapted to fit within a mesiobuccal groove located on the associated first or second adjoining tooth, and a lingual middle part connection which is adapted to fit within a lingual middle part located on the associated first or second adjoining tooth.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is an embodiment of a prior art crown bridge.

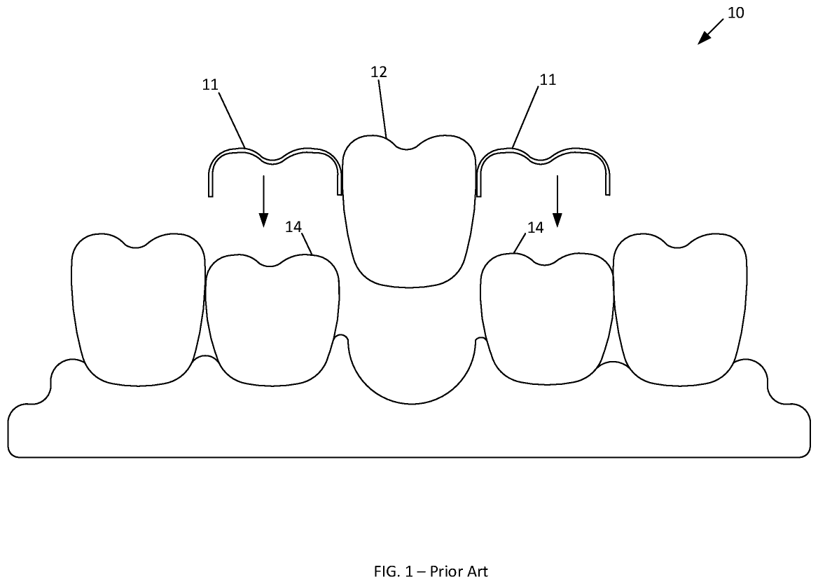

FIG. 2 is a perspective view of an embodiment of an adjoining tooth showing the location of specific retention grooves in preparation for use with embodiments of the present invention.

FIG. 3 is perspective view of an embodiment of a dental protheses of the present invention illustrating an embodiment of the crown.

FIG. 4 is perspective view of an embodiment of a dental protheses of the present invention illustrating an embodiment of the first and second abutments.

FIG. 5 is back view of an embodiment of the first and second connectors showing a plurality of connecting points of the present invention.

FIG. 6 is top view of an additional embodiment of a dental protheses of the present invention illustrating an embodiment of the first and second abutments.

FIG. 7 is perspective view of an embodiment of an adjoining tooth showing the location of specific retention grooves.

FIG. 8 is perspective view of an embodiment a connector of a dental protheses being affixed to the specific retention grooves shown in FIG. 7.

FIG. 9 is perspective view of an embodiment a connector of a dental protheses being affixed to the specific retention grooves shown in FIG. 7.

FIG. 10 is perspective lingual view of an embodiment of an adjoining tooth showing the location of specific retention grooves.

FIG. 11 is perspective buccal view of an embodiment of an adjoining tooth showing the location of specific retention grooves of the embodiment shown in FIG. 10.

FIG. 12 is perspective lingual view of an embodiment a connector of a dental protheses being affixed to the specific retention grooves shown in FIG. 10.

FIG. 13 is perspective buccal view of an embodiment a connector of a dental protheses being affixed to the specific retention grooves shown in FIG. 11.

### DETAILED DESCRIPTION FO THE INVENTION

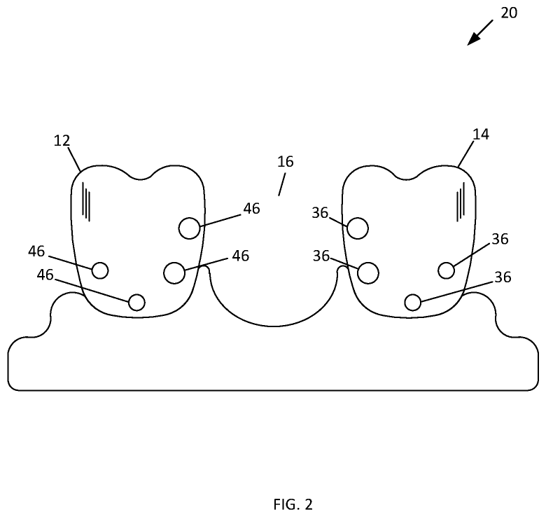

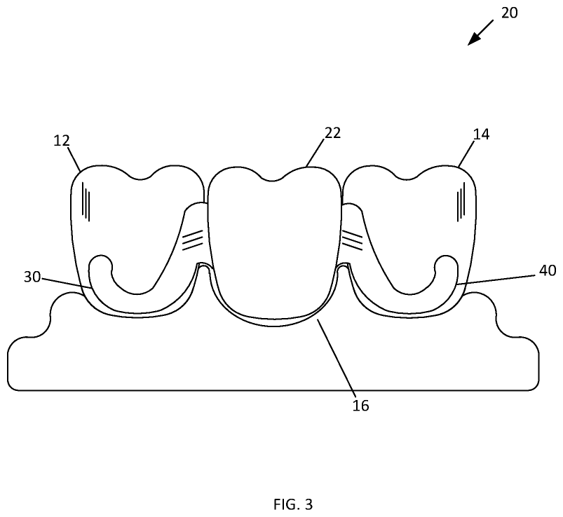

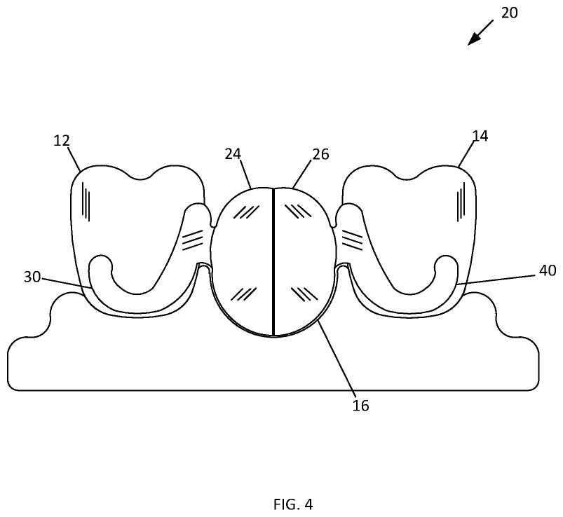

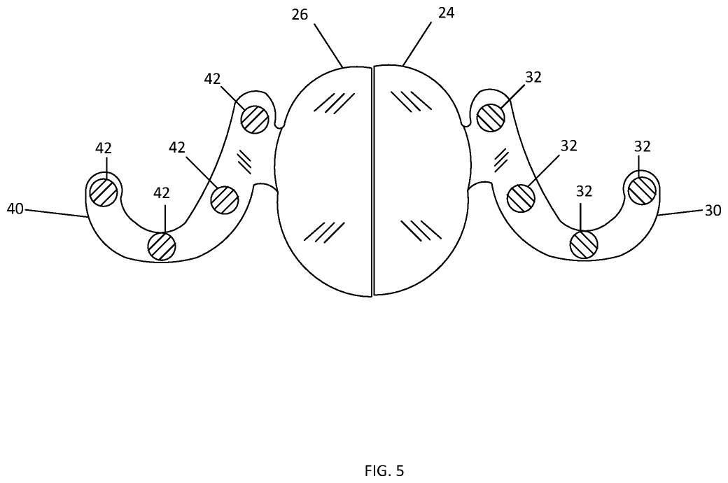

As illustrated in the FIGS. 2-5, an embodiment of the dental prothesis 20 pursuant to the present invention is disclosed. Dental prothesis 20 is configured to be placed in a gap 16 between a first adjoining tooth 12 and a second adjoining tooth 14 so as to replace a missing tooth.

Dental prothesis 20 is designed to be inserted easier than the prior art bridge protheses. While the prior art bridge protheses require the grinding down of the adjacent natural teeth in order to accommodate the crown portions of the bridge over the natural teeth, dental prothesis 20 does not require significant grinding of the adjacent teeth. As the installation of prior art bridge protheses requires the significant reduction of the adjoining natural tooth, dental prothesis 20 requires only the reduction of approximately less than five percent (5%) of the adjoining tooth. Accordingly, the installation of dental prothesis 20 does not require the patient to be subject to general anesthesia or similar sedation. This allows for an easier installation for the doctor and a more comfortable installation for the patient.

Further, the limited amount of natural tooth reduction allows for a faster healing period for the patient. Dental prothesis 20 also has an advantage in that, due to the limited amount of adjoining tooth reduction, the risk of permanent damage to the adjoining tooth is minimized. This reduces the risk of the patient having to undergo implant surgery, which can cause nerve damage to the patient, due to a failure of the prothesis due to the damage of the adjoining teeth.

In this embodiment, dental prothesis 20 includes a first partial abutment 24 being designed to sit within gap 16. A first connector 30 is secured to the first partial abutment 24 and secured to the first adjoining tooth 12. First connector 30 is substantially C-shaped configuration and adapted to fit along the surface of the first adjoining tooth 12. Further, first connector 30 has a plurality of first connector connecting points 32 adapted to fit within one of a plurality of first retention grooves 36 ground in the first adjoining tooth 12. The amount of reduction of the first adjoining tooth 12 by the plurality of first retention grooves 36 is approximately less than five percent (5%) of the entire tooth. This allows first connector 30 to be fixed, or secured, to the first adjacent tooth 12 with little grinding of the first adjacent tooth 12;

Dental prothesis 20 also includes a second partial abutment 26 configured to sit within the gap 16. First partial abutment 24 and second partial abutment 26 are designed to form a complete abutment. An artificial tooth, or crown, 22 is placed over and around the first partial abutment 24 and the second partial abutment 26.

A second connector 40 is secured to the second partial abutment 26 and secured to the second adjoining tooth 14. Second connector 40 is substantially C-shaped configuration and adapted to fit along the surface of the second adjoining tooth 14. Further, second connector 40 has a plurality of second connector connecting points 42 adapted to fit within one of a plurality of second retention grooves 46 ground in the second adjoining tooth 14. As with the first retention grooves 36, the amount of reduction of the second adjoining tooth 14 by the plurality of second retention grooves 46 is approximately less than five percent (5%) of the entire tooth.

In some embodiments, the first connector 30 and the second connector 40 may be made from a metal material or a zirconia material.

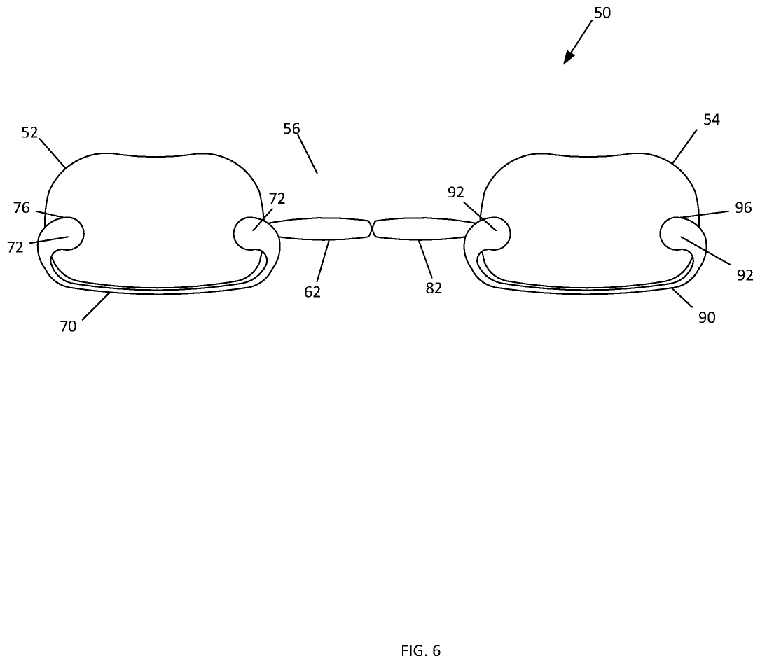

As illustrated in the FIG. 6, an additional embodiment of the dental prothesis 50 pursuant to the present invention is disclosed. Dental prothesis 20 is configured to be placed in a gap 56 between a first adjoining tooth 52 and a second adjoining tooth 54 so as to replace a missing tooth.

In this embodiment, dental prothesis 50 includes a first partial abutment 62 being designed to sit within gap 56. A first connector 70 is secured to the first partial abutment 62 and secured to the first adjoining tooth 52. First connector 70 is substantially C-shaped configuration and adapted to fit along the surface of the first adjoining tooth 52. Further, first connector 70 has a plurality of first connector connecting points 72 adapted to fit within one of a plurality of first retention grooves 76 ground in the first adjoining tooth 52.

Dental prothesis 50 also includes a second partial abutment 62 configured to sit within the gap 56. First partial abutment 52 and second partial abutment 62 are designed to form a complete abutment.

A second connector 90 secured to the second partial abutment 82, the second connector 90 secured to the second adjoining tooth 54. The second connector 90 being in a substantially C-shape configuration and adapted to fit along the surface of the second adjoining tooth 54. The second connector 90 has a plurality of second connector connecting points 92. Each of the second connector connecting points 92 being adapted to fit within one of a plurality of second retention grooves 96 ground in the second adjoining tooth 54 to fix the second connector 90 to the second adjacent tooth 54 with little grinding of the second adjacent tooth 54.

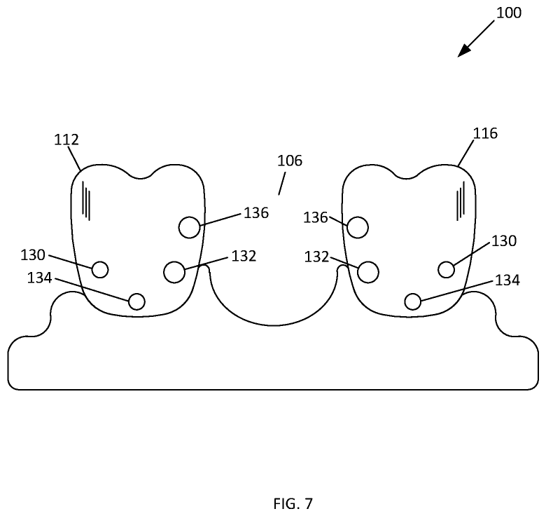

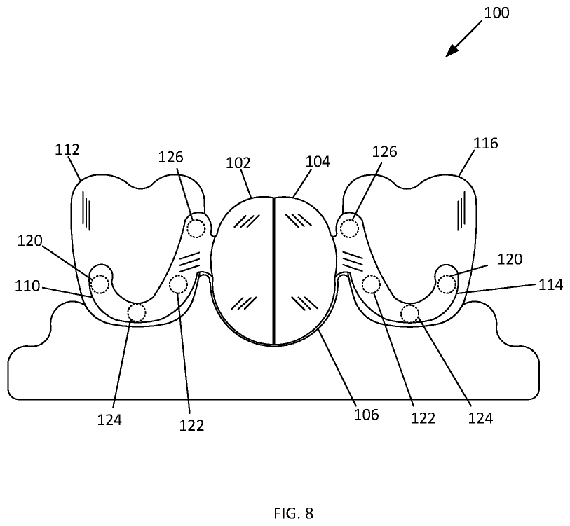

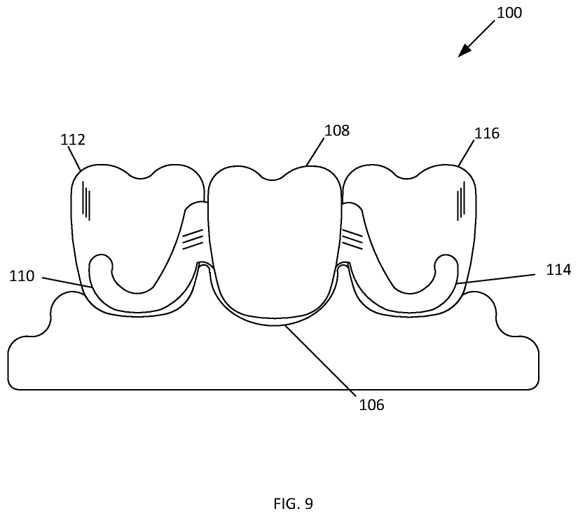

As illustrated in FIGS. 7-9, an example of the present invention is disclosed. This example utilizes an embodiment of a dental prothesis 100 to replace an anterior tooth. In this example, a first partial abutment 102 and a second partial abutment 104 sit within gap 106. First partial abutment 102 and second partial abutment 104 are designed to form a complete abutment. An artificial tooth, or crown, 108 is placed over and around the first partial abutment 102 and the second partial abutment 104 to form a replacement tooth.

A first connector 110 is secured to the first partial abutment 102 secured to the first adjoining tooth 112. A second connector 114 is secured to the second partial abutment 104 secured to the first adjoining tooth 116. Both the first connector 110 and second connector 114 are substantially C-shaped and adapted to fit along the surface of the respective first and second adjoining teeth 112, 116. Further, both first connector 110 and second connector 114 have four connecting points 120, 122, 124 and 126 adapted to fit within one of a four retention grooves 130, 132, 134 and 136 ground in the first and second adjoining teeth 112, 116.

The first retention groove 130 is the distolingula groove, and has the purpose of providing physical retention of the connectors 110, 114 to the first and second adjoining teeth 112, 116. The second retention groove 132 is the mesiolingual groove, and has the purpose of providing mechanical retention of the connectors 110, 114 to the first and second adjoining teeth 112, 116. The third retention groove 134 is the cingulum groove and has the purpose of providing physical retention of the connectors 110, 114 to the first and second adjoining teeth 112, 116 and to provide support to prevent the loosening of dental prothesis 100. The fourth retention groove 136 is the mesiolingual groove and has the purpose of providing physical retention of the connectors 110, 114 to the first and second adjoining teeth 112, 116.

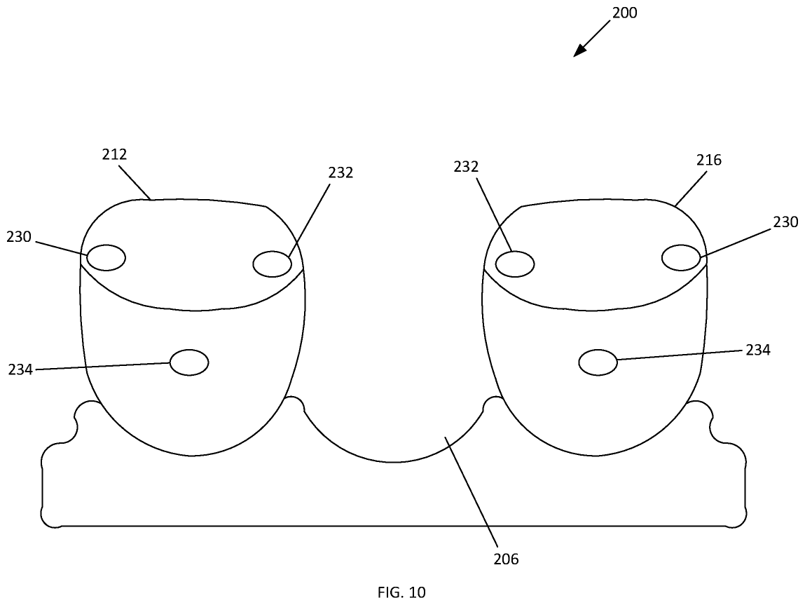

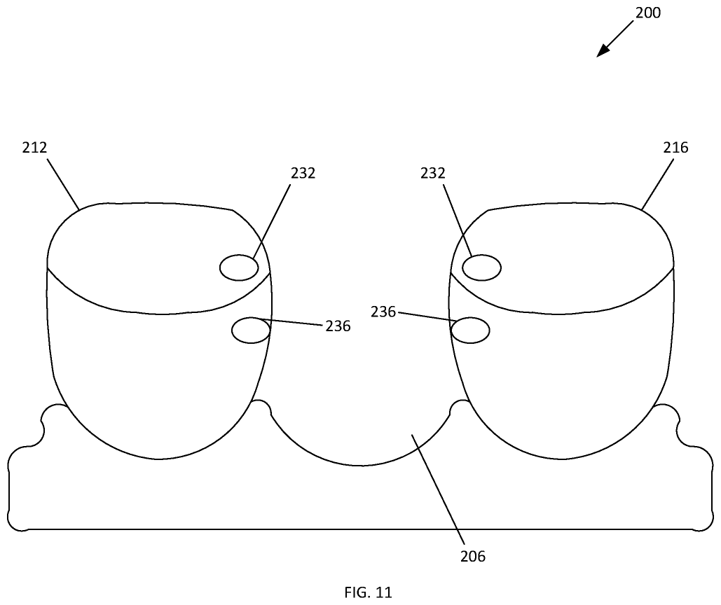

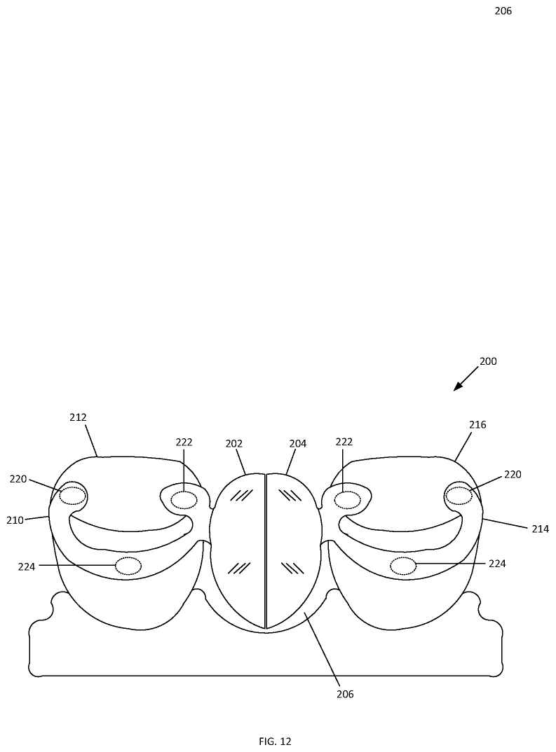

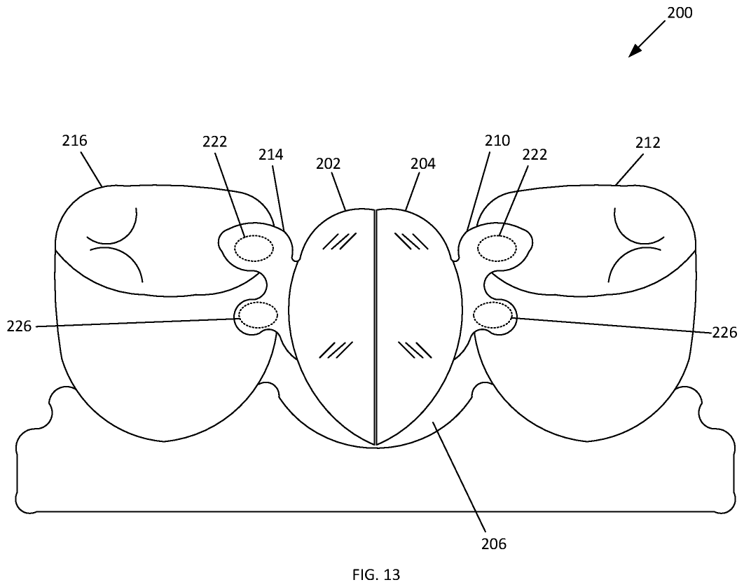

As illustrated in FIGS. 10-13, an example of the present invention is disclosed. This example utilizes an embodiment of a dental prothesis 200 to replace a posterior tooth. In this example, a first partial abutment 202 and a second partial abutment 204 sit within gap 206. First partial abutment 202 and second partial abutment 204 are designed to form a complete abutment. An artificial tooth, or crown, not shown, is placed over and around the first partial abutment 202 and the second partial abutment 204 to form a replacement tooth.

A first connector 210 is secured to the first partial abutment 202 and secured to the first adjoining tooth 212. A second connector 214 is secured to the second partial abutment 204 and secured to the second adjoining tooth 216. Both the first connector 210 and second connector 214 are substantially C-shaped and adapted to fit along the surface of the respective first and second adjoining teeth 212, 216. Further, both first connector 210 and second connector 214 have four connecting points 220, 222, 224 and 226 adapted to fit within one of a four retention grooves 230, 232, 234 and 236 ground in the first and second adjoining teeth 112, 116.

The first retention groove 230 is the dirto-occlusion groove, and has the purpose of providing a stress break from occlusal force and to provide physical retention of the connectors 210, 214 to the first and second adjoining teeth 212, 216. The second retention groove 132 is the mesio-occlusion groove and has the purpose of providing a stress break from occlusal force and to provide physical retention of the connectors 210, 214 to the first and second adjoining teeth 212, 216. The third retention groove 234 is the cervical groove and has the purpose of providing physical retention of the connectors 210, 214 to the first and second adjoining teeth 212, 216 and to provide support to prevent the loosening of dental prothesis 200. The fourth retention groove 236 is the mesiobuccal groove and has the purpose of providing stability to crown 208.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A dental prothesis configured to simulate a missing tooth and to be placed in a gap between a first adjoining tooth and a second adjoining tooth so as to replace the missing tooth, the prothesis comprising:
a first partial abutment configured to sit within the gap;
a second partial abutment configured to sit within the gap and adjacent to the first partial abutment, the first partial abutment and the second partial abutment configured to form a complete abutment;
a first connector secured to the first partial abutment, the first connector secured to the first adjoining tooth, the first connector being in a substantially C-shape configuration and adapted to fit along the surface of the first adjoining tooth, the first connector having a plurality of first connector connecting points, each first connector connecting point being adapted to fit within one of a plurality of first retention grooves ground in the first adjoining tooth to affix the first connector to the first adjacent tooth with little grinding of the first adjacent tooth;
a second connector secured to the second partial abutment, the second connector secured to the second adjoining tooth, the second connector being in a substantially C-shape configuration and adapted to fit along the surface of the second adjoining tooth, the second connector having a plurality of second connector connecting points, each second connector connecting point being adapted to fit within one of a plurality of second retention grooves ground in the second adjoining tooth to affix the second connector to the second adjacent tooth with little grinding of the second adjacent tooth; and
a crown adapted to fit over and about the first and second partial abutments.

2. The dental prothesis of claim 1 wherein each of the first and second connector is metal material

3. The dental prothesis of claim 1 wherein each of the first and second connector is zirconia material.

4. The dental prothesis of claim 1, for each of the first connector and the second connector the number of the plurality of connecting points is four, wherein the four connecting points are further defined as:
a mesial occlusion connection point adapted to fit within a mesial occlusion groove located on the associated first or second adjoining tooth;
a distal occlusion connection point adapted to fit within a distal occlusion groove located on the associated first or second adjoining tooth;
a mesiobuccal connection point adapted to fit within a mesiobuccal groove located on the associated first or second adjoining tooth; and
a lingual middle part connection adapted to fit within a lingual middle part located on the associated first or second adjoining tooth.
